(19) United States
(12) Patent Application Publication
(10) Pub. No.: US 2010/0100851 A1
(43) Pub. Date: Apr. 22, 2010

(54) MAPPING A REAL-WORLD OBJECT IN A PERSONAL VIRTUAL WORLD

(75) Inventors: Jason T. Clark, Raleigh, NC (US); Amy H. Dewar, Durham, NC (US); Robert C. Leah, Cary, NC (US); Nicholas E. Poore, Durham, NC (US); Peter C. Yim, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/253,230

(22) Filed: Oct. 16, 2008

(51) Int. Cl. G06F 3/048

(52) U.S. Cl. 715/849

(57) ABSTRACT

Embodiments of the present invention provide a method, system and computer program product for mapping a real-world object to a virtual object in a virtual world. In an embodiment of the invention, a method for mapping a real-world object to a virtual object in a virtual world can include, generating a view to a virtual world for a participant to a virtual world and rendering an avatar for the participant in the view to the virtual world, locating a geographic position of a real-world object outside of the virtual world, mapping the located geographic position to a location in the virtual world, and displaying a counterpart representation of the real-world object in the view at the mapped location in the virtual world.

### BACKGROUND OF THE INVENTION

1. Field of the Invention

The present invention relates to the field of virtual reality and more particularly to real-world object representation in a virtual world.

2. Description of the Related Art

A virtual world is a computer-based simulated environment constructed for participants to inhabit and interact via corresponding avatars. Avatars are usually depicted as three-dimensional graphical representations of real-world participants to the virtual world. Virtual worlds typically rely on mentally and emotionally engaging content, which gives rise to an immersive experience. As virtual worlds come closer and closer to simulating reality, both in appearance and function, participant prefer an environment that closely resembles real life. While much of the landscape and buildings in a virtual world are imaginary, some virtual structures have been created based on actual physical entities in the real world outside of the virtual world.

Virtual worlds are well known as being fantasy spaces sealed off from the real world, but more careful analysis reveals that the boundaries between virtual world and the outside world known as real life are quite permeable. Participants constantly arrive and depart from the world, carrying with a unique set of cultural assumptions and behavioral attitudes that usually cannot be disentangled from virtual interactions in the virtual world.

The ability and technical know-how to create a more realistic virtual world containing references to real world objects can be difficult for the novice participant. Current techniques include tagging generic objects in the virtual world; however, a drawback remains in the lack of customization of a personal tailored view of the virtual world. Having a virtual presence within the online community opens new opportunities for virtual space meetings, lectures, training courses and networking and social opportunities for users. Yet, it would be desirable to more realistically represent real world objects and structures in the virtual world to facilitate interactions between participants in a realistic virtual setting.

### BRIEF SUMMARY OF THE INVENTION

Embodiments of the present invention provide a method, system and computer program product for mapping a real-world object to a virtual object in a virtual world. In an embodiment of the invention, a method for mapping a real-world object to a virtual object in a virtual world can include, generating a view to a virtual world for a participant to the virtual world and rendering an avatar for the participant in the view to the virtual world, locating a geographic position of a real-world object outside of the virtual world, mapping the located geographic position to a location in the virtual world, and displaying a counterpart representation of the real-world object in the view at the mapped location in the virtual world.

In another embodiment, locating the geographic position of the real-world object outside of the virtual world can include determining GPS coordinates of the real-world object.

In yet another embodiment, displaying the counterpart representation of the real-world object in the view at the mapped location in the virtual world, can include scaling the counterpart representation according to physical measurements of the real-world object outside of the virtual world, and displaying the scaled counterpart representation in the view at the mapped location in the virtual world.

In another embodiment, displaying the counterpart representation of the real-world object in the view at the mapped location in the virtual world can include determining a privacy setting for the counterpart representation, displaying the counterpart representation of the real-world object in the view at the mapped location in the virtual world only when permitted by the privacy setting, otherwise suppressing a display of the counterpart representation. Furthermore, the method can include tagging the counterpart representation in the virtual world with annotated text.

A virtual world data processing system can also be provided in another embodiment. The system can include a virtual world server executing in a host server, a mobile computing device enabled for interoperation with a global positioning system (GPS), a virtual machine manager logic coupled to the host server, the logic including program code enabled to generate a view in a virtual world for a participant to the virtual world and to render an avatar for the participant in the view, to locate a geographic position of a real-world object outside of the virtual world, to map the located geographic position to a location in the virtual world, and to display a counterpart representation of the real-world object in the view at the mapped location in the virtual world.

Additional aspects of the invention will be set forth in part in the description, which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for mapping a real-world object to a virtual object in a virtual world;

FIG. 2 is a schematic illustration of a virtual world data processing system configured for mapping a real-world object to a virtual object in a virtual world; and

FIG. 3 is a flow chart illustrating a process for mapping a real-world object to a virtual object in a virtual world.

### DETAILED DESCRIPTION OF THE INVENTION

Embodiments of the present invention provide a method, system and computer program product for mapping a real-world object to a virtual object in a virtual world. In accordance with an embodiment of the present invention, a virtual world can be generated for a number of participants to the virtual world. Each participant can be represented by an avatar disposed within a view of the virtual world that is personal to the participant. Thereafter, a geographic position of an object outside of the virtual world can be located and the geographic position can be mapped to a location in the virtual world. Finally, a counterpart representation of the object can be displayed in the view at the mapped location. Optionally, each counterpart representation displayed in the virtual view can be scaled in the view according to a physical measurement and geographical position of the object outside of the virtual world in order to accurately preserve actual distance between different counterpart representations of other objects in the view. In this way, a realistic feeling of real life can be imparted upon the view in the virtual world.

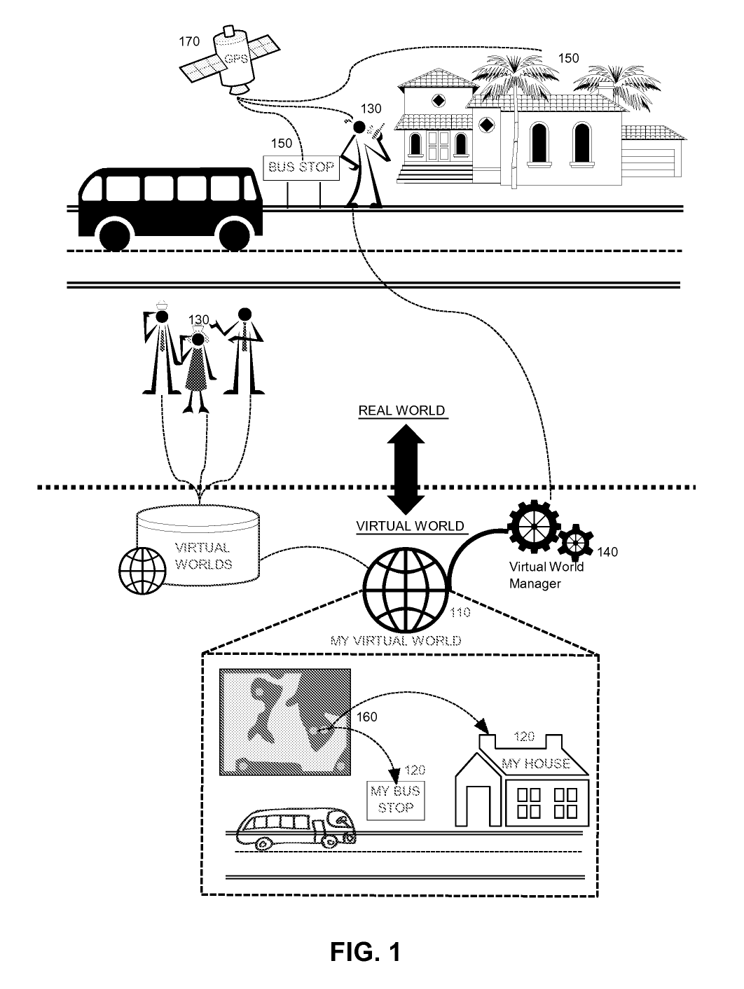

In illustration, FIG. 1 pictorially depicts a process for mapping a real-world object to a virtual object in a virtual world. As shown in FIG. 1, a virtual world 110 can include multiple different locations 120. Participants 130 can interact with the different locations 120 in the virtual world 110 through respective avatars. Further, participants 130 can create new locations 120 in the virtual world and participants 130 can create new objects in those locations 120.

A virtual world manager 140 also can be provided in order to map and manage real-world objects 150 outside of the virtual world 110 as counterpart representations within the virtual world 110. Specifically, participants 130 can interact with the virtual world manager 140 by locating a geographic position of an object 150 outside of the virtual world 110. For example, the geographic position of an object 150 outside the virtual world 110 can be determined via global positioning system (GPS) data 170 for the object 150 and provided to the virtual world manager 140 as GPS coordinates.

Notably, the geographic position provided to the virtual world manager 140 can be mapped to a location 120 in the virtual world 110. In this regard, a counterpart representation of the object 150 can be displayed in a view 160 at the mapped location 120 in the virtual world 110. Each counterpart representation displayed in the view 160 can be scaled according to physical measurements of the object 150 in order to accurately preserve actual distance between different counterpart representations of objects 150 in the view 160.

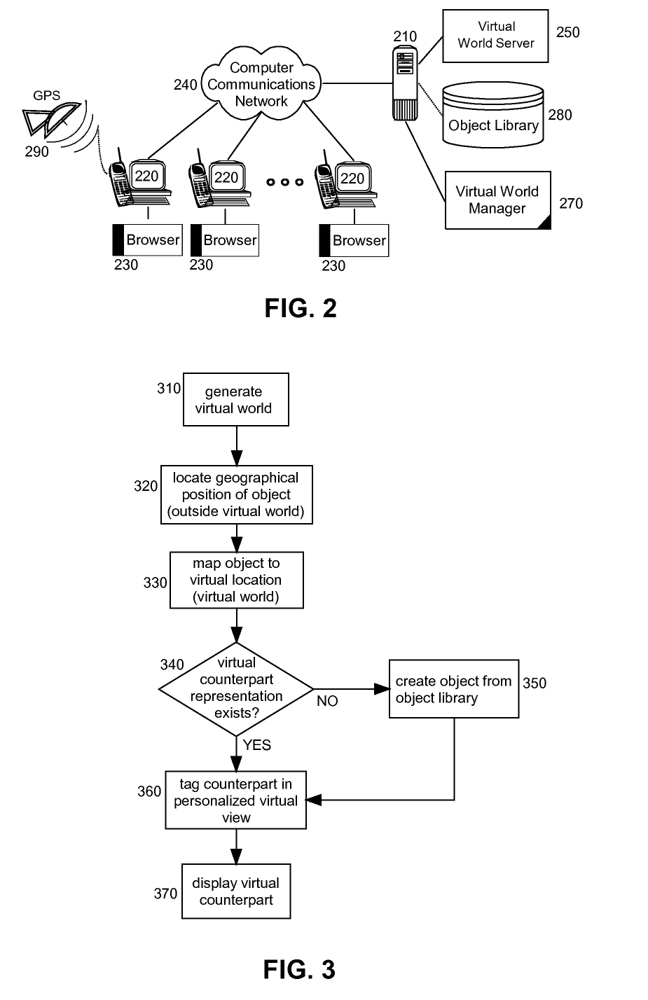

The process described in connection with FIG. 1 can be embodied within a virtual world data processing system. In illustration, FIG. 2 depicts a virtual world data processing system configured for mapping a real-world object to a virtual object in a virtual world. The system can include a host server 210, each configured for coupling to clients 220 over computer communications network 240. Host server 210 can host the operation of a virtual world server 250 configured to generate and manage access to virtual worlds over computer communications network 240. An object library 280 also can be coupled to the host server and can store both counterpart representations of real-world objects and corresponding locations within different virtual worlds managed by the virtual world server 250. Access by participants to the different virtual worlds managed by virtual world server 210 can be provided by way of browsers 230 for corresponding clients 220.

In accordance with the inventive embodiments, virtual world manager logic 270 can be coupled to the host server 210. The virtual world manager logic 270 can include program code for mapping a real-world object to a counterpart representation of the real-world object in a virtual world managed by the virtual world server 250. In this regard, the program code can be enabled to locate a geographic position of a real-world object existing outside of the virtual world in response to which the program code can be further enabled to map the located geographic position to a location in the virtual world. The program code further can be enabled to display the counterpart representation of the real-world object in a view to the virtual world at the mapped location in the virtual world.

In yet further illustration of the operation of the virtual world manager 270, FIG. 3 is a flow chart illustrating a process for mapping a real-world object to a virtual object in a virtual world. The process can begin in block 310 with the generating/loading of a view in a virtual world including different locations and objects positioned at the different locations. Different views can be provided for the virtual world, each personal to a specific participant to the virtual world. In block 320, the geographical position of a real-world object outside of the virtual world can be located. For example, the location of the real-world object can be determined by the placement of a location device such as a GPS receiver or a GPS enabled cellular telephone in proximity to the real-world object.

In block 330, the geographical position of the real-world object can be mapped to a corresponding location in the virtual world based upon the geographical position of the real-world object outside of the virtual world. Next in block 340, it can be determined whether a pre-existing counterpart representation of the real-world object already has been mapped. If not, in block 350 a counterpart representation of the real-world object can be created in an object library for the virtual world in connection with the corresponding location in the virtual world. Otherwise, the counterpart representation can be tagged in block 360 in a personalized view of the virtual world.

In particular, explanatory text can be associated with the counterpart representation. Further, privacy settings can be established for the counterpart representation to designate the counterpart representation as publicly viewable or private and not publicly viewable. Finally in block 370, the virtual counterpart representation either scaled to the dimensions of the corresponding real-world object, or otherwise, can be rendered in a personalized view at the mapped location in the virtual world.

Embodiments of the invention can take the form of an entirely hardware embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for mapping a real-world object to a virtual object in a virtual world comprising:
generating a view to a virtual world for a participant to the virtual world and rendering an avatar for the participant in the view to the virtual world;
locating a geographic position of a real-world object outside of the virtual world;
mapping the located geographic position to a location in the virtual world; and
displaying a counterpart representation of the real-world object in the view at the mapped location.

2. The method of claim 1, wherein locating the geographic position of the real-world object outside of the virtual world comprises determining GPS coordinates of the real-world object.

3. The method of claim 1, wherein displaying the counterpart representation of the real-world object at the mapped location in the virtual world, comprises:
scaling the counterpart representation according to physical measurements of the real-world object outside of the virtual world; and,
displaying the scaled counterpart representation in the view at the mapped location in the virtual world.

4. The method of claim 1, wherein displaying the counterpart representation of the real-world object in the view at the mapped location in the virtual world, comprises:
determining a privacy setting for the counterpart representation; and,
displaying the counterpart representation of the real-world object in the view at the mapped location in the virtual world only when permitted by the privacy setting, but otherwise suppressing a display of the counterpart representation.

5. The method of claim 1, further comprising tagging the counterpart representation in the virtual world with annotated text.

6. A virtual world data processing system comprising:
a virtual world server executing in a host server;
a mobile computing device enabled for interoperation with a global positioning system (GPS);
virtual machine manager logic coupled to the virtual world server, the logic comprising program code enabled to generate a view to a virtual world for a participant to the virtual world and to render an avatar for the participant in the view to the virtual world, to locate a geographic position of a real-world object outside of the virtual world, to map the located geographic position to a location in the virtual world, and to display a counterpart representation of the real-world object in the view at the mapped location in the virtual world.

7. A computer program product comprising a computer usable medium embodying computer usable program code for mapping a real-world object to a virtual object in a virtual world, the computer program product comprising:
computer usable program code for generating a view to a virtual world for a participant to the virtual world and rendering an avatar for the participant in the view to the virtual world;
computer usable program code for locating a geographic position of a real-world object outside of the virtual world;
computer usable program code for mapping the located geographic position to a location in the virtual world; and
computer usable program code for displaying a counterpart representation of the real-world object in the view at the mapped location in the virtual world.

8. The computer program product of claim 7, wherein the computer usable program code for locating the geographic position of the real-world object outside of the virtual world comprises computer usable program code for determining global positioning system (GPS) coordinates of the real-world object.

9. The computer program product of claim 7, wherein the computer usable program code for displaying the counterpart representation of the real-world object in the view at the mapped location in the virtual world, comprises:
computer usable program code for scaling the counterpart representation according to physical measurements of the real-world object outside of the virtual world; and,
computer usable program code for displaying the scaled counterpart representation in the view at the mapped location in the virtual world.

10. The computer program product of claim 7, wherein the computer usable program code for displaying the counterpart representation of the real-world object in the view at the mapped location in the virtual world, comprises:
computer usable program code for determining a privacy setting for the counterpart representation; and,
computer usable program code for displaying the counterpart representation of the real-world object in the view at the mapped location in the virtual world only when permitted by the privacy setting, but otherwise suppressing a display of the counterpart representation.

11. The computer program product of claim 7, further comprising computer usable program code for tagging the counterpart representation in the virtual world with annotated text.
